(19) United States
(12) Patent Application Publication
(10) Pub. No.: US 2011/0261682 A1
(43) Pub. Date: Oct. 27, 2011

(54) APPARATUS AND METHOD FOR TRANSMITTING AND RECEIVING DYNAMIC LANE INFORMATION IN MULTI-LANE BASED ETHERNET

(75) Inventor: Kyeongeun HAN, Daejeon (KR)

(73) Assignee: Electronics and Telecommunications Research Institute, Daejeon (KR)

(21) Appl. No.: 12/942,690

(22) Filed: Nov. 9, 2010

(30) Foreign Application Priority Data
Apr. 26, 2010 (KR) 10-2010-0038388

(51) Int. Cl. G06F 11/00

(52) U.S. Cl. 370/225

(57) ABSTRACT

Provided is an apparatus and method of transmitting and receiving dynamic lane information that may generate and transmit a lane status information frame containing lane information for exchanging of lane information and variable lane adjustment, in order to dynamically operate a number of lanes in multi-lane based Ethernet.

### CROSS-REFERENCE TO RELATED APPLICATION

This application claims the benefit of Korean Patent Application No. 10-2010-0038388, filed on Apr. 26, 2010, in the Korean Intellectual Property Office, the disclosure of which is incorporated herein by reference.

### BACKGROUND

1. Field of the Invention

Embodiments of the present invention relate to a method and apparatus for transmitting and receiving lane information that is dynamically modified in a multi-lane based Ethernet apparatus.

2. Description of the Related Art

Currently, 40 Gbps and 100 Gbps Ethernet communication standardization is ongoing as a high speed wideband transmission system. A multi-lane structure where a single high speed transmission link is configured using a plurality of lanes having a relatively low transmission rate has been adopted as a structure for 40 Gbps and 100 Gbps Ethernet. For this, the standard defines a common physical layer for 40 Gbps and 100 Gbps Ethernet. With respect to the respective 40 Gbps Ethernet and 100 Gbps Ethernet, the standard defines a number of Physical Coding Sublayers (PCSs) as four and 20, and defines a number of physical lanes per link as four and ten.

Multi-lane based Ethernet defines, as ten, a number of electrical lanes configured between a Physical Medium Attachment (PMA) layer and a Physical Medium Dependent (PMD) layer with respect to a 100 Gbps Ethernet apparatus, and defines, as four, the number of electrical lanes with respect to a 40 Gbps Ethernet apparatus. Here, each electrical lane may transfer data in correspondence to a plurality of optical lanes via the PMA layer.

A current standard discloses a data transmission using a defined fixed lane. However, in multi-lane based Ethernet, there may be provided a variety of schemes that may effectively use and manage a network by dynamically operating a number of lanes based on a network state, a traffic state, or when an error occurs.

In existing multi-lane based Ethernet, transmission and reception of data may be performed in parallel using a pre-determined lane. Transmission and reception processing including a synchronization and an alignment may be performed when data is normally received from all the lanes. Accordingly, to dynamically operate multiple lanes according to a corresponding intent, lane change information may need to be exchanged between transmission side Ethernet and reception side Ethernet and thereby information processing may need to be appropriately performed.

### SUMMARY

An aspect of the present invention provides a method and apparatus for transmitting and receiving dynamic lane information in multi-lane based Ethernet.

Another aspect of the present invention also provides a structure of a lane status information frame including lane information used for exchanging of lane information and a variable lane adjustment, in order to dynamically operate a number of lanes in multi-lane based Ethernet.

Another aspect of the present invention also provides a multi-lane based Ethernet transmission apparatus that may generate a lane status information frame containing dynamically varying lane information and may transmit the lane information to an Ethernet reception apparatus.

Another aspect of the present invention also provides a multi-lane based Ethernet reception apparatus that may modify a lane based on lane information contained in a lane status information frame when the lane status information frame is received from an Ethernet transmission apparatus.

According to an aspect of the present invention, there is provided an apparatus for transmitting dynamic lane information in an Ethernet transmission apparatus, including: an upper layer to dynamically modify a lane based on an Ethernet network, a traffic state, and a fault of the Ethernet network; a lane information transmitter to generate and transmit a lane status information frame containing lane change information; and a lane adjustment unit to adjust the lane based on the lane change information.

According to another aspect of the present invention, there is provided an apparatus of receiving dynamic lane information in an Ethernet reception apparatus, including: a lane information verifying unit to receive a lane status information frame using all the lanes being currently used, and to verify a lane status in the received lane status information frame; and a lane adjusting unit to modify a using lane based on the verified lane status.

According to still another aspect of the present invention, there is provided a method of transmitting dynamic lane information in an Ethernet transmission apparatus, including: dynamically modifying a lane based on an Ethernet network, a traffic state, and a fault of the Ethernet network; generating and transmitting a lane status information frame containing lane change information; and adjusting the lane based on the lane change information.

According to a further another aspect of the present invention, there is provided a method of receiving dynamic lane information in an Ethernet reception apparatus, including: receiving a lane status information frame using all the lanes being currently used; verifying a lane status in the received lane status information frame; and modifying a using lane based on the verified lane status.

### EFFECT

According to embodiments of the present invention, there may be provided a method and apparatus that may generate, and thereby transmit and receive a lane status information frame including lane information used for exchanging of lane information and a variable lane adjustment, in order to dynamically operate a number of lanes in multi-lane based Ethernet. A lane status may be expressed by making a physical lane correspond to each bit of a status field. Accordingly, it is possible to effectively transfer information regarding a lane status and a lane number with respect to a single lane or multiple lanes, and a number of lanes.

In addition, an apparatus of transmitting dynamic lane information may transmit a lane status information frame using all the lanes depending on whether a lane status is modified. Accordingly, a reception side may more readily predict whether a modification is made, and apply the lane status information frame when dynamically operating a number of lanes, or when a lane fault occurs.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of multi-lane based Ethernet according to an embodiment of the present invention;

FIG. 2 is a diagram illustrating a hierarchical structure of an Ethernet transmission apparatus and an Ethernet reception apparatus according to an embodiment of the present invention;

FIG. 3 illustrates a format of a lane status information frame according to an embodiment of the present invention;

FIG. 4 illustrates a format of a status field of the lane status information frame of FIG. 3;

FIG. 5 is a flowchart illustrating a process of generating and transmitting a lane status information frame in an Ethernet transmission apparatus according to an embodiment of the present invention; and

FIG. 6 is a flowchart illustrating a process of receiving a lane status information frame to modify a lane in an Ethernet reception apparatus according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

According to embodiments of the present invention, to dynamically operate a number of lanes in multi-lane based Ethernet, there may be provided a structure of a lane status information frame including lane information for a lane information exchange and a variable lane adjustment. Also, there may be provided an Ethernet transmission and reception apparatus and method that may transmit and receive the lane status information frame.

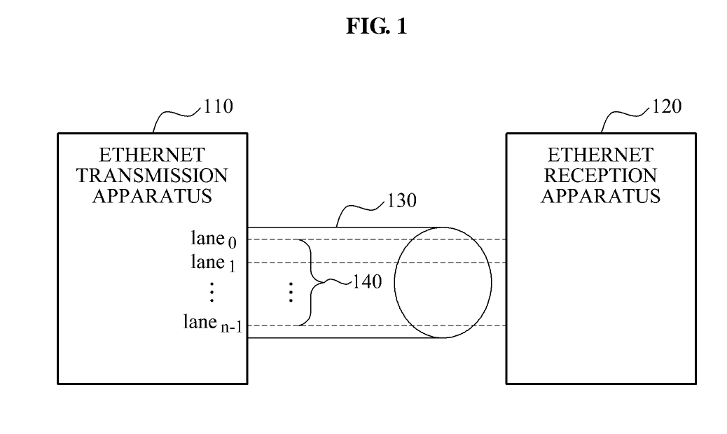

FIG. 1 is a diagram illustrating a configuration of multi-lane based Ethernet according to an embodiment of the present invention.

Referring to FIG. 1, 40 Gbps and 100 Gbps Ethernet based on multiple lanes may include an Ethernet transmission apparatus 110 and an Ethernet reception apparatus 120. The Ethernet transmission apparatus 110 and the Ethernet reception apparatus 120 may be connected with each other via a single link 130 including a plurality of optical lanes 140.

The Ethernet transmission apparatus 110 may transmit a single data stream in parallel by dividing the single data stream using each of the optical lanes 140, for example, laneₒ through laneₙ₋₁. The present invention may be applicable to all the links and physical media based on multiple lanes such as the optical lanes 140, electrical lanes, and the like.

High speed Ethernet using a multi-lane based single link may dynamically modify each lane based on a network state, a traffic state, or when a network fault occurs. To dynamically utilize a lane depending on circumstances, the Ethernet transmission apparatus 110 and the Ethernet reception apparatus 120 may need to be mutually aware of lane change information. The lane change information may be different according to a purpose of a lane operation. For example, the lane change information may include a fault lane number, a number of fault lanes, an available lane number, a number of available lanes, a number of lanes currently required based on a network state or a traffic state, a lane number, and the like.

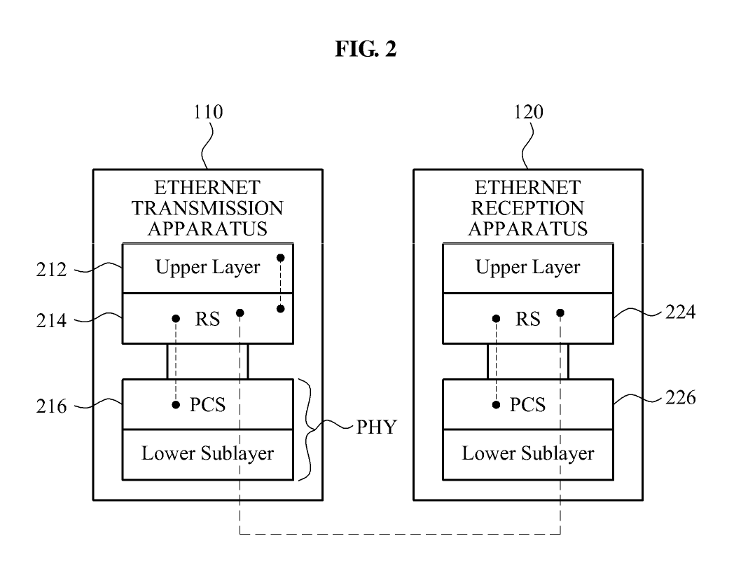

FIG. 2 is a diagram illustrating a hierarchical structure of an Ethernet transmission apparatus 110 and an Ethernet reception apparatus 120 according to an embodiment of the present invention.

Ethernet layers may include an upper layer, a Reconciliation Sublayer (RS), a Physical Coding Sublayer (PCS), and a lower sublayer. The RS and the PCS may be connected with each other via a Media Independent Interface (MII). Here, the upper layer indicates RS upper layers including a Media Access Control (MAC) layer. The lower sublayer indicates PCS lower sublayers within a physical layer (PHY).

When a portion of the entire transmission band is desired to be dynamically converted and thereby be used in multi-lane based Ethernet, a dynamical operation based on each lane of a link may be enabled. For example, it is possible to variably operate a number of lanes based on a circumstance by using maximum four lanes in the case of 40 Gbps Ethernet and by using maximum ten lanes in the case of 100 Gbps Ethernet.

The Ethernet transmission apparatus 110 and the Ethernet reception apparatus 120 based on multiple lanes may need to independently perform a synchronization and an alignment according to each lane. Accordingly, when dynamically using a number of lanes to be suitable for a network state, there is a need to adjust a number of lanes currently used between the communicating Ethernet transmission apparatus 110 and the Ethernet reception apparatus 120.

An upper layer 212 of the Ethernet transmission apparatus 110 may transfer, to a lane information transmitter (not shown) included in an RS 214, a lane status information frame containing a change in a number of lanes that is determined according to a policy.

A lane adjustment unit (not shown) included in a PCS 216 may perform lane adjustment based on lane information that is modified according to the policy.

The lane information transmitter receiving the lane status information frame may transmit the lane status information frame to a lane information verifying unit (not shown) included in an RS 224 of the Ethernet reception apparatus 120. The lane information verifying unit included in the RS 224 may transmit lane status information included in the received lane status information frame to a lane adjustment unit (not shown) included in a PCS 226, in order to apply the lane status information to a transmission and reception process.

The lane adjustment unit included in the PCS 226 may modify a using lane based on a lane status verified by the lane information verifying unit.

The lane status information frame may be transferred from the RS 214 to the RS 224 using a sequence ordered-set frame.

A lane information transfer scheme may vary depending on a configuration scheme, such as a scheme of using a frame defined in another layer, a scheme using a separate signal, and the like.

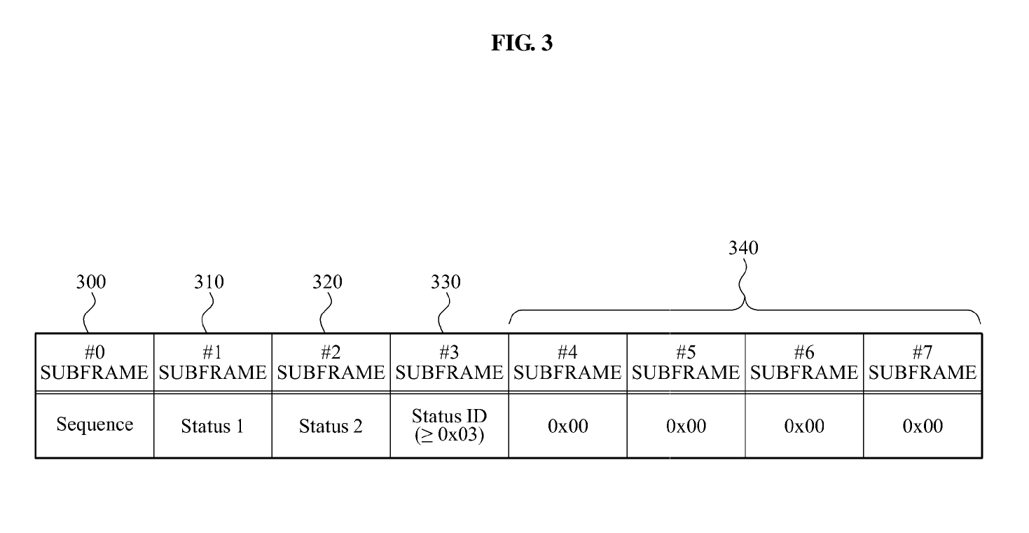

FIG. 3 illustrates a format of a lane status information frame according to an embodiment of the present invention.

Referring to FIG. 3, a sequence ordered-set frame that is reserved as the lane status information frame may be defined and thereby be used.

The lane status information frame provided in a form of the sequence ordered-set frame may include eight subframes. Each of the eight sub frames may include eight bits. Hereinafter, a configuration of each subframe will be described.

Here, a zero^{th} subframe 300 indicates a sequence value expressing the sequence ordered-set frame. Each of a first subframe 310 and a second subframe 320 indicates a lane status based on a number of lanes constituting a link. A third subframe 330 indicates type information used to indicate a type of the sequence ordered-set frame. Specifically, the third frame 330 may be used as information to classify a lane status.

For example, when the third frame 330 corresponds to 0x01 and 0x2, a standard may respectively define 0x01 and 0x2 as a local fault and a remote fault for link faults, and thereby use. Accordingly, the third frame 330 may be used to identify a variety of faults and a control frame using a value of at least 0x03. Remaining lanes, that is, subframes 340 correspond to reserved fields and thus may be set to have a value of 0x00.

In the first subframe 310 and the second subframe 320 indicating the lane status, each bit corresponds to each physical lane and thereby, indicates a corresponding lane status.

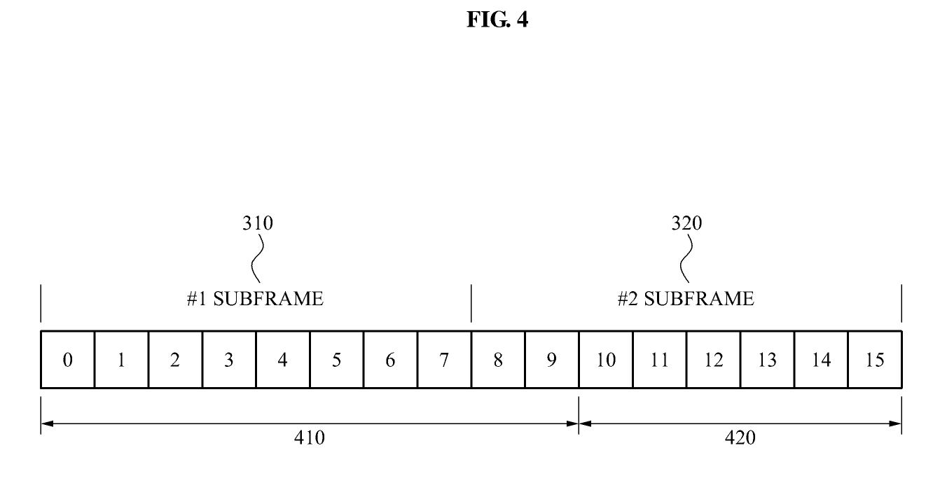

FIG. 4 illustrates a format of a status field of the lane status information frame of FIG. 3.

Since a lane status field of each of the first subframe 310 and the second subframe 320 includes eight bits, it is possible to indicate a status of each lane using a total of 16 bits. Bits may sequentially correspond to the physical lanes lane₀ through laneₙ₋₁ of FIG. 1.

Although a total of 16 lane statuses are indicated herein, it is possible to indicate lane status information by using a single subframe or a plurality of subframes based on a number of lanes being used, or by using other lanes excluding the first subframe 310 and the second subframe 320. For example, since four physical lanes are used for 40 Gpbs Ethernet and ten physical lanes are used for 100 Gbps Ethernet, it is possible to indicate the lane status information using remaining bits 410 excluding six bits 420 of the second subframe 320. An unused bit may have a value of “0”.

Although a sequence ordered-set frame is used as one example here, a separate frame format including the above information and identification method may be defined in other layers, for example, an RS upper layer and an RS lower layer, and thereby be used in order to transfer a lane state information frame. Specifically, a lane information transmitter may be configured to be included in the RS upper layer or the RS lower layer according to a corresponding frame format.

The above scheme may simultaneously transmit status information associated with not only a single lane but also multiple lanes, a number of lanes used, and lane number information. A bit corresponding to each lane may be set to have a value of “0” or “1”. Through this, it is possible to transmit information regarding whether a corresponding lane is available or faulty, a number of available lanes, a number of unavailable lanes, and the like.

As one example, when only two lanes, for example, laneₒ and laneₛ, are desired to be used due to a network state while using four lanes, for example, laneₒ through lane₃ in 40 Gbps Ethernet, a zero^{th} bit and a first bit of the first subframe 310 may be set to have a value of “1” (or “0”), and remaining bits may be set to have a value of “0” (or “1”). As another example, when a lane fault occurs in lane₃ of 40 Gbps Ethernet, a third bit of the first subframe 310 of FIG. 4 may be set to have a value of “1”. When using a scheme of matching each bit with each lane, it is possible to readily provide status information with respect to not only a single lane but also multiple lanes. Specifically, it is possible to be aware of a lane number and a current lane availability based on a corresponding bit. In addition, by counting a number of bits of a lane status field set to have a value of “1” (or “0”), it is possible to be aware of information associated with a number of available lanes.

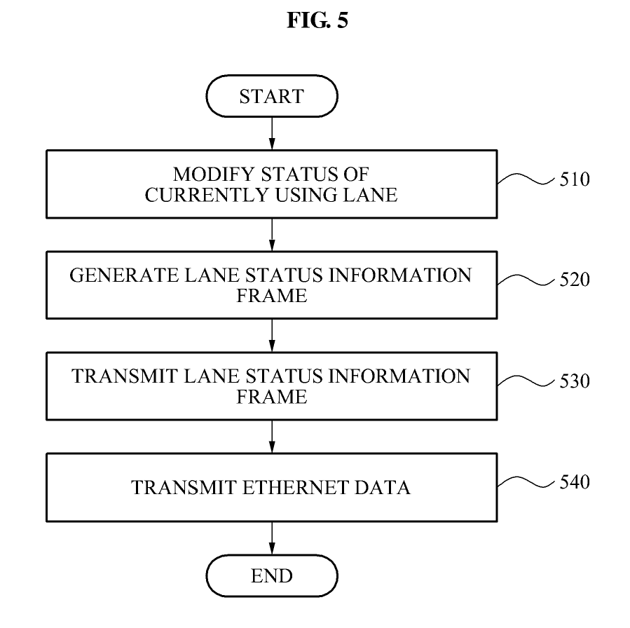

FIG. 5 is a flowchart illustrating a process of generating and transmitting a lane status information frame in an Ethernet transmission apparatus according to an embodiment of the present invention.

Referring to FIG. 5, based on a network state or when a lane fault occurs, the Ethernet transmission apparatus may modify a status of a currently using lane to be suitable for a corresponding circumstance in operation 510.

In operation 520, the Ethernet transmission apparatus may generate a lane status information frame including lane information that is modified or gathered using a lane status or a mechanism.

In operation 530, the Ethernet transmission apparatus may transmit the lane status information frame to an Ethernet reception apparatus using all the lanes. Here, a number of virtual lanes between a PCS and a Physical Medium Attachment (PMA) layer may be different from a number of electrical lanes configured between a Physical Medium Attachment (PMA) layer and a Physical Medium Dependent (PMD) layer, a number of physical lanes constituting a link. Accordingly, the RS may generate a number of lane status information frames corresponding to the number of virtual lanes used in the PCS, and thereby transmit the generated number of lane status information frames. Accordingly, the Ethernet reception apparatus may also receive at least two lane status information frames using a single lane.

Modification and adjustment of lane information between the Ethernet transmission apparatus and the Ethernet reception apparatus may be performed through a request-response procedure, a request-response-verification procedure, and the like, based on the lane status information frame.

When the lane is modified, the Ethernet transmission apparatus may transmit Ethernet data in parallel to the Ethernet reception apparatus using the modified lane in operation 540.

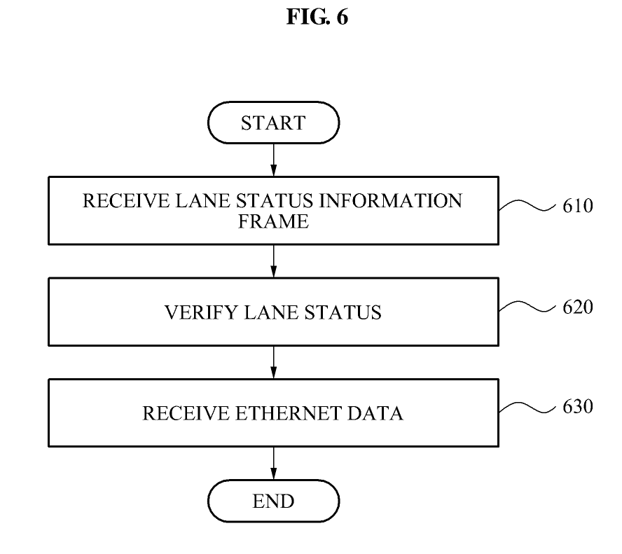

FIG. 6 is a flowchart illustrating a process of receiving a lane status information frame to modify a lane in an Ethernet reception apparatus according to an embodiment of the present invention.

Referring to FIG. 6, in operation 610, the Ethernet reception apparatus may receive a lane status information frame using all the currently using lanes.

In operation 620, the Ethernet reception apparatus may verify a lane status in the received lane status information frame. In this instance, a method of verifying and processing the lane status in the lane status information frame may vary based on information associated with a third subframe that is a fourth subframe of the lane status information frame. As one example, when a defined delay time is elapsed, however, when a number of received lane status information frames is less than a number of lanes being currently used, the Ethernet reception apparatus may verify whether the received lane status information frame corresponds to a sequence ordered-set frame, whether information of the third subframe corresponds to a value indicating a fault occurrence and thereby may determine whether a lane fault or error occurs.

In operation 630, the Ethernet reception apparatus may receive Ethernet data using a modified lane based on lane status information that is verified from the lane status information frame.

The above-described embodiments of the present invention may be recorded in computer-readable media including program instructions to implement various operations embodied by a computer. The media may also include, alone or in combination with the program instructions, data files, data structures, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for transmitting dynamic lane information in an Ethernet transmission apparatus, comprising:
an upper layer to dynamically modify a lane based on an Ethernet network, a traffic state, and a fault of the Ethernet network;
a lane information transmitter to generate and transmit a lane status information frame containing lane change information; and
a lane adjustment unit to adjust the lane based on the lane change information.

2. The apparatus of claim 1, wherein the lane change information comprises at least one of a fault lane number, a number of fault lanes, an available lane number, a number of available lanes, a number of currently required lanes, and a currently required lane number.

3. The apparatus of claim 1, wherein the lane status information frame comprises status information indicating a status of each lane and type information indicating a usage type of the lane status information frame.

4. The apparatus of claim 3, wherein the type information comprises at least one of various faults, information associated with a required lane, and lane control information.

5. The apparatus of claim 3, wherein the status information indicates a status for each lane suitable for the type information.

6. The apparatus of claim 3, wherein the status information indicates a status of each lane suitable for the type information that is indicated as a single bit for each lane.

7. The apparatus of claim 1, wherein the lane status information frame is provided in a form of a sequenced ordered-set frame comprising a first subframe containing a sequence value that indicates the sequence ordered-set frame, a second subframe and a third subframe indicating a status of each lane, and a fourth subframe indicating a usage type of the lane status information frame.

8. The apparatus of claim 7, wherein each of the second subframe and the third subframe indicates a status of a lane corresponding to each bit using a total of 16 bits.

9. An apparatus of receiving dynamic lane information in an Ethernet reception apparatus, comprising:
a lane information verifying unit to receive a lane status information frame using all the lanes being currently used, and to verify a lane status in the received lane status information frame; and
a lane adjusting unit to modify a using lane based on the verified lane status.

10. The apparatus of claim 9, wherein when a delay time defined in the lane status information frame is elapsed, and when a number of received lane status information frames is less than a total number of lanes being currently used, the lane information verifying unit determines whether a fault or an error exists based on type information included in the lane status information frame.

11. The apparatus of claim 9, wherein the lane status information frame comprises status information indicating a status of each lane and type information indicating a usage type of the lane status information frame.

12. The apparatus of claim 11, wherein the type information comprises at least one of various faults, information associated with a required lane, and lane control information.

13. The apparatus of claim 11, wherein the status information indicates a status of each lane suitable for the type information.

14. The apparatus of claim 11, wherein the status information indicates a status of each lane suitable for the type information that is indicated as a single bit for each lane.

15. The apparatus of claim 9, wherein the lane status information frame is provided in a form of a sequenced ordered-set frame comprising a first subframe containing a sequence value that indicates the sequence ordered-set frame, a second subframe and a third subframe indicating a status of each lane, and a fourth subframe indicating a usage type of the lane status information frame.

16. The apparatus of claim 15, wherein each of the second subframe and the third subframe indicates a status of a lane corresponding to each bit using a total of 16 bits.

17. A method of transmitting dynamic lane information in an Ethernet transmission apparatus, comprising:
dynamically modifying a lane based on an Ethernet network, a traffic state, and a fault of the Ethernet network;
generating and transmitting a lane status information frame containing lane change information; and
adjusting the lane based on the lane change information.

18. A method of receiving dynamic lane information in an Ethernet reception apparatus, comprising:
receiving a lane status information frame using all the lanes being currently used;
verifying a lane status in the received lane status information frame; and
modifying a using lane based on the verified lane status.
